(19) United States
(12) Patent Application Publication
(10) Pub. No.: US 2022/0137289 A1
(43) Pub. Date: May 5, 2022

(54) SINGLE-MODE FIBER WITH LOW DISPERSION SLOPE

(71) Applicant: CORNING INCORPORATED, Corning, NY (US)

(72) Inventors: Xin Chen, Painted Post, NY (US); Hao Dong, Horseheads, NY (US); Kangmei Li, San Jose, CA (US); Ming-Jun Li, Horseheads, NY (US); Pushkar Tandon, Painted Post, NY (US); Scott Robertson Bickham, Corning, NY (US)

(21) Appl. No.: 17/514,060

(22) Filed: Oct. 29, 2021

Related U.S. Application Data
(60) Provisional application No. 63/107,909, filed on Oct. 30, 2020.

(51) Int. Cl. G02B 6/028; G02B 6/02

(52) U.S. Cl. CPC G02B 6/0281; G02B 6/02214

(57) ABSTRACT

A optical fiber comprising a central core region having an outer radius r₁ of 3 μm to 7 μm, and a maximum refractive index Δ₁ of 0.25% to 0.5% and an alpha (a) profile of 1 to 20; a cladding region comprising (i) a first inner cladding region surrounding the core, having a refractive index Δ₂ of −0.25% to 0.05% and a radius r₂ of 6 μm to 15 μm, (ii) a second inner cladding region, surrounding the first inner cladding region, having a refractive index Δ₃ of −0.1% to 0.2% and a radius r₃ of 7 μm to 15 μm, and (iii) an outer cladding region, surrounding the second inner cladding region, having a refractive index Δ₄ between −0.05% to 0.1%; wherein the optical fiber exhibits a cable cutoff of less than 1260 nm, a mode field diameter at 1310 nm of greater than 8.2 microns.

### CROSS-REFERENCE TO RELATED APPLICATIONS

This application claims the benefit of priority under 35 U.S.C. § 119 of U.S. Provisional Application Ser. No. 63/107,909 filed on Oct. 30, 2020, the content of which is relied upon and incorporated herein by reference in its entirety.

### FIELD

The present disclosure pertains to optical fibers. More particularly, the present disclosure relates to optical fibers having low dispersion slope.

### BACKGROUND

Standard single-mode fibers that meet G.652 standard are widely used in different transmission systems. For data center interconnects, for example, it is desirable to have transmission distance greater than 10 km. Another application is the use of the fiber in converged access networks and for front haul in 5G networks. These network use multiple channel transmission in the O-band. The reach in these applications are limited by the fiber dispersion in the channels at higher wavelengths, such as between 1260 and 1380 nm. A single mode fiber with low dispersion slope can enable longer transmission distance.

Accordingly, the inventors have developed improved single-mode optical fibers with low dispersion slope.

### SUMMARY

A first embodiment of the present disclosure includes an optical fiber, comprising: a central core region having an outer radius r₁ of 3 μm to 7 μm, and a maximum refractive index Δ₁ of 0.25% to 0.5% and an alpha (a) profile of 1 to 20; a cladding region comprising (i) a first inner cladding region surrounding the central core, having a refractive index Δ₂ of −0.25% to 0.05% and a radius r₂ of 6 μm to 15 μm, (ii) a second inner cladding region, surrounding the first inner cladding region, having a refractive index Δ₃ of −0.1% to 0.2% and a radius r₃ of 7 μm to 15 μm, and (iii) an outer cladding region, surrounding the second inner cladding region, having a refractive index Δ₄ between −0.05% to 0.1%; wherein the optical fiber exhibits a cable cutoff of less than 1260 nm, a mode field diameter at 1310 nm of greater than 8.2 microns and a chromatic dispersion slope at 1310 nm of less than or equal to 0.083 ps/nm²/km.

A second embodiment of the present disclosure may include the first embodiment, wherein the outer radius r₁ of the central core is 3.5 μm to 5.5 μm.

A third embodiment of the present disclosure may include the first and second embodiment, wherein the maximum refractive index Δ₁ of the central core is 0.3% to 0.45%.

A fourth embodiment of the present disclosure may include the first to third embodiments, wherein the refractive index Δ₂ of the first inner cladding region is 0 to −0.2%.

A fifth embodiment of the present disclosure may include the first to fourth embodiment, wherein the outer radius r₂ of the first inner cladding region is 6.5 μm to 10 μm.

A sixth embodiment of the present disclosure may include the first to fifth embodiment, wherein the refractive index Δ₃ of the second inner cladding region is 0.05% to 0.15%.

A seventh embodiment of the present disclosure may include the first to sixth embodiment, wherein the optical fiber exhibits a zero-dispersion wavelength λ₀ of less than 1400 nm.

A eighth embodiment of the present disclosure may include the first to sixth embodiment, wherein the optical fiber exhibits a zero-dispersion wavelength λ₀ of less than 1390 nm.

A ninth embodiment of the present disclosure may include the first to sixth embodiment, wherein the optical fiber exhibits a zero-dispersion wavelength λ₀ of less than 1380 nm.

A tenth embodiment of the present disclosure may include the first to sixth embodiment, wherein the optical fiber exhibits a zero-dispersion wavelength λ₀ of 1300 nm to 1324 nm.

A eleventh embodiment of the present disclosure may include the first to tenth embodiment, wherein the optical fiber exhibits an attenuation at 1310 nm and 1383 nm of less than 0.33 dB/km.

A twelfth embodiment of the present disclosure may include the first to tenth embodiment, wherein the optical fiber exhibits an attenuation at 1310 nm and 1383 nm of less than 0.32 dB/km.

A thirteenth embodiment of the present disclosure may include the first to twelfth embodiment, wherein the optical fiber exhibits a mode field diameter greater than 8.5 microns at 1310 nm.

A fourteenth embodiment of the present disclosure may include the first to twelfth embodiment, wherein the optical fiber exhibits a mode field diameter greater than 9 microns at 1310 nm.

A fifteenth embodiment of the present disclosure may include the first to fourteenth embodiment, wherein the optical fiber exhibits a chromatic dispersion slope at 1310 nm of less than or equal to 0.07 ps/nm²/km.

A sixteenth embodiment of the present disclosure may include the first to fourteenth embodiment, wherein the optical fiber exhibits a chromatic dispersion slope at 1310 nm of less than or equal to 0.0675 ps/nm²/km.

A seventeenth embodiment of the present disclosure may include the first to fourteenth embodiment, wherein the optical fiber exhibits a chromatic dispersion at 1310 nm of greater than −7 ps/nm/km.

A eighteenth embodiment of the present disclosure may include the first to fourteenth embodiment, wherein the optical fiber exhibits a chromatic dispersion at 1310 nm of greater than −6 ps/nm/km.

A nineteenth embodiment of the present disclosure may include the first to fourteenth embodiment, wherein the optical fiber exhibits a chromatic dispersion at 1380 nm of less than 5 ps/nm/km.

A twentieth embodiment of the present disclosure may include the first to fourteenth embodiment, wherein the optical fiber exhibits a chromatic dispersion at 1260 nm of greater than −10 ps/nm/km.

A twenty-first embodiment of the present disclosure may include the first to twentieth embodiment, wherein the optical fiber exhibits a bend loss of less than 0.00001 dB/turn when would upon a 60 mm radius mandrel.

A twenty-second embodiment of the present disclosure includes an optical fiber, comprising: a central core region having an outer radius r₁ of 3 μm to 5.5 μm, and a maximum refractive index Δ₁ of 0.25% to 0.5% and an alpha (a) profile of 1 to 20; and a cladding region comprising (i) a first inner cladding region surrounding the central core, having a refractive index Δ₂ of −0.25% to 0.05% and a radius r₂ of 6 μm to 12 μm, (ii) a second inner cladding region, surrounding the first inner cladding region, having a refractive index Δ₃ of 0.02% to 0.2% and a radius r₃ of 7 μm to 15 μm, and (iii) an outer cladding region, surrounding the second inner cladding region, having a refractive index Δ₄ between −0.05% to 0.1%; wherein the optical fiber exhibits a cable cutoff of less than 1260 nm, mode field diameter at 1310 nm of greater than 8.2 microns, a zero dispersion wavelength between 1300 nm and 1324 nm and a chromatic dispersion slope at 1310 nm of less than or equal to 0.083 ps/nm²/km.

A twenty-third embodiment of the present disclosure may include the twenty-second embodiment, wherein the optical fiber exhibits a mode field diameter at 1310 nm of greater than 8.6 microns.

A twenty-fourth embodiment of the present disclosure may include the twenty-second embodiment, wherein the optical fiber exhibits a mode field diameter at 1310 nm of greater than 9 microns.

A twenty-fifth embodiment of the present disclosure includes an optical fiber, comprising: a central core region having an outer radius r₁ of 3 μm to 5.5 μm, and a maximum refractive index Δ₁ of 0.25% to 0.5% and an alpha (a) profile of 1 to 20; and a cladding region comprising (i) a first inner cladding region surrounding the central core, having a refractive index Δ₂ of −0.25% to 0.05% and a radius r₂ of 6 μm to 12 μm, (ii) a second inner cladding region, surrounding the first inner cladding region, having a refractive index Δ₃ of 0.02% to 0.2% and a radius r₃ of 7 μm to 15 μm, and (iii) an outer cladding region, surrounding the second inner cladding region, having a refractive index Δ₄ between −0.05% to 0.1%; wherein the optical fiber exhibits a cable cutoff of less than 1260 nm, a mode field diameter at 1310 nm of greater than 8.2 microns, a zero dispersion wavelength of less than 1400 nm and a chromatic dispersion slope at 1310 nm of less than or equal to 0.075 ps/nm²/km.

A twenty-sixth embodiment of the present disclosure may include the twenty-fifth embodiment, wherein the optical fiber exhibits a zero dispersion wavelength of less than 1390 nm.

A twenty-seventh embodiment of the present disclosure may include the twenty-fifth embodiment, wherein the optical fiber exhibits a zero dispersion wavelength of less than 1380 nm.

A twenty-eighth embodiment of the present disclosure may include the twenty-fifth embodiment, wherein the optical fiber exhibits a dispersion slope of less than 0.07 ps/nm²/km at 1310 nm.

A twenty-ninth embodiment of the present disclosure may include the twenty-fifth embodiment, wherein the optical fiber exhibits a dispersion slope of less than 0.068 ps/nm²/km at 1310 nm.

A thirtieth embodiment of the present disclosure may include the twenty-fifth embodiment, wherein the optical fiber exhibits a mode field diameter at 1310 nm of greater than 8.6 microns.

A thirty-first embodiment of the present disclosure may include the twenty-fifth embodiment, wherein the optical fiber exhibits a mode field diameter at 1310 nm of greater than 9 microns.

A thirty-second embodiment of the present disclosure may include the twenty-fifth embodiment, wherein the optical fiber exhibits a bend loss of less than 0.00001 dB/turn when would upon a 60 mm radius mandrel.

### BRIEF DESCRIPTION OF THE DRAWINGS

The accompanying drawings are included to provide a further understanding, and are incorporated in and constitute a part of this specification. The drawings illustrate one or more embodiment(s), and together with the Detailed Description serve to explain principles and operation of the various embodiments. As such, the disclosure will become more fully understood from the following Detailed Description, taken in conjunction with the accompanying Figures, in which:

FIG. 1 is a side perspective view of an optical fiber according to one embodiment of the present disclosure;

FIG. 2 schematically depicts a cross-section of the multicore optical fiber depicted in FIG. 1, according to one or more embodiments described herein;

FIG. 3 graphically depicts a relative refractive index profile of an exemplary optical fiber, according to one or more embodiments described herein;

FIG. 4A-4C graphically depicts relative refractive index profiles of exemplary optical fibers, according to one or more embodiments described herein.

FIG. 5 graphically depicts relative refractive index profiles of exemplary optical fibers, according to one or more embodiments described herein.

### DETAILED DESCRIPTION

Reference is now made in detail to various embodiments of the disclosure, examples of which are illustrated in the accompanying drawings. Whenever possible, the same or like reference numbers and symbols are used throughout the drawings to refer to the same or like parts. The drawings are not necessarily to scale, and one skilled in the art will recognize where the drawings have been simplified to illustrate the key aspects of the disclosure. The claims as set forth below are incorporated into and constitute part of this Detailed Description.

In this document, relational terms, such as first and second, top and bottom, and the like, are used solely to distinguish one entity or action from another entity or action, without necessarily requiring or implying any actual such relationship or order between such entities or actions.

It will be understood by one having ordinary skill in the art that construction of the described disclosure, and other components, is not limited to any specific material. Other exemplary embodiments of the disclosure disclosed herein may be formed from a wide variety of materials, unless described otherwise herein.

In embodiments, the optical fiber disclosed herein includes a central core region. The core region may include a central axis and extend from the central axis to a radius r₁. The core region comprises a relative refractive index Δ₁ relative to pure silica. A cladding region may encircle and directly contact the core region. The cladding region comprising a first inner cladding region, a second inner cladding region, and an outer cladding region. The first inner cladding region (also referred to as the trench region or the depressed index cladding region) may encircle and directly contact the central core. The first inner cladding region comprises a refractive index Δ₂ relative to pure silica and extend from radius r₁ to radius r₂. The second inner cladding region (also referred to as the ring region) may encircle and directly contact the first inner cladding region. The second inner cladding region comprises a refractive index Δ₃ and extends from the radius r₂ to radius r₃. The outer cladding region may encircle and directly contact the second inner cladding region. The outer cladding region comprises a refractive index Δ₄ comprises and extends from the radius r₂ to radius r₄. Various embodiments of optical fibers will be described herein in further detail with specific reference to the appended drawings.

In this specification and in the claims, which follow, reference will be made to a number of terms which shall be defined to have the following meanings:

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

“Radial position” and/or “radial distance,” when used in reference to the radial coordinate “r” refers to radial position relative to the centerline (r=0) of the central core portion in the optical fiber.

The length dimension “micrometer” may be referred to herein as micron (or microns) or μm.

The “refractive index profile” is the relationship between refractive index or relative refractive index and radial distance r from the core portion's centerline. For relative refractive index profiles depicted herein as relatively sharp boundaries between various regions, normal variations in processing conditions may result in step boundaries at the interface of adjacent regions that are not sharp. It is to be understood that although boundaries of refractive index profiles may be depicted herein as step changes in refractive index, the boundaries in practice may be rounded or otherwise deviate from perfect step function characteristics. It is further understood that the value of the relative refractive index may vary with radial position within the core region and/or any of the cladding regions. When relative refractive index varies with radial position in a particular region of the fiber (core region and/or any of the cladding regions), it may be expressed in terms of its actual or approximate functional dependence or in terms of an average value applicable to the region. Unless otherwise specified, if the relative refractive index of a region (core region and/or any of the inner and/or common cladding regions) is expressed as a single value, it is understood that the relative refractive index in the region is constant, or approximately constant, and corresponds to the single value or that the single value represents an average value of a non-constant relative refractive index dependence with radial position in the region. Whether by design or a consequence of normal manufacturing variability, the dependence of relative refractive index on radial position may be sloped, curved, or otherwise non-constant.

Unless stated otherwise, the “relative refractive index percent” is defined as Δ %=100×(nᵢ²−n_{c}²)/²nᵢ², and as used herein n is the average refractive index of undoped silica glass. As used herein, the relative refractive index is represented by A and its values are given in units of “%”, unless otherwise specified. The terms: relative refractive index percent, relative refractive index, refractive index delta, refractive index, relative refractive index delta, delta, Δ, Δ %, % Δ, delta %, % delta and percent delta may be used interchangeably herein. In cases where the refractive index of a region is less than the average refractive index of undoped silica, the relative index percent is negative and is referred to as having a depressed region or depressed index. In cases where the refractive index of a region is greater than the average refractive index of the cladding region, the relative index percent is positive. An “updopant” is herein considered to be a dopant which has a propensity to raise the refractive index relative to pure undoped SiO₂. A “downdopant” is herein considered to be a dopant which has a propensity to lower the refractive index relative to pure undoped SiO₂. Examples of updopants include GeO₂ (germania), Al₂O₃, P₂O₅, TiO₂, Cl, and/or Br. Examples of downdopants include fluorine and B₂O₃. As described herein, while the relative refractive index of the optical profiles are calculated where index of nₑ is undoped silica, the entire index profile of the optical fiber can be shifted linearly up (or down) in order to obtain equivalent optical fiber properties,

The term “α-profile” (also referred to as an “alpha profile”) refers to a relative refractive index profile Δ(r) that has the following functional form:

$$Δ ( r ) = Δ ( {r}_{0} ) \{ 1 - {[ \frac{\vert r - {r}_{0} \vert}{( {r}_{1} - {r}_{0} )} ]}^{α} \}$$

where rₒ is the point at which Δ(r) is maximum, r₁ is the point at which Δ(r) is zero, and r is in the range rᵢ≤r≤r_{f}, where rᵢ is the initial point of the α-profile, r_{f} is the final point of the α-profile, and α is a real number. In embodiments, examples shown herein can have a core alpha of 1≤α≤100. In practice, an actual optical fiber, even when the target profile is an alpha profile, level of deviation from the ideal configuration can occur. Therefore, the alpha parameter for an optical fiber may be obtained from a best fit of the measured index profile, as is known in the art.

The term “graded-index profile” refers to an α-profile, where α<10. The term “step-index profile” refers to an α-profile, where α≥10.

The “effective area” can be defined as:

$${A}_{e f f} = \frac{2 {π [ {\int }_{0}^{∞} {( f ( r ) )}^{2} r d r ]}^{2}}{{\int }_{0}^{∞} {( f ( r ) )}^{4} r d r}$$

where f(r) is the transverse component of the electric field of the guided optical signal and r is radial position in the fiber. “Effective area” or “A_{eff}” depends on the wavelength of the optical signal. Specific indication of the wavelength will be made when referring to “Effective area” or “Δ_{eff}” herein. Effective area is expressed herein in units of “μm²”, “square micrometers”, “square microns” or the like.

Unless otherwise noted herein, optical properties (such as dispersion, dispersion slope, etc.) are reported for the LP01 mode.

“Chromatic dispersion,” herein referred to as “dispersion” unless otherwise noted, of an optical fiber is the sum of the material dispersion, the waveguide dispersion, and the intermodal dispersion. “Material dispersion” refers to the manner in which the refractive index of the material used for the optical core affects the velocity at which different optical wavelengths propagate within the core. “Waveguide dispersion” refers to dispersion caused by the different refractive indices of the core and cladding of the optical fiber. In the case of single mode waveguide fibers, the inter-modal dispersion is zero. Dispersion values in a two-mode regime assume intermodal dispersion is zero. The zero dispersion wavelength (λ₀) is the wavelength at which the dispersion has a value of zero. Dispersion slope is the rate of change of dispersion with respect to wavelength. Dispersion and dispersion slope are reported herein at a wavelength of 1310 nm or 1550 nm, as noted, and are expressed in units of ps/nm/km and ps/nm²/km, respectively. Chromatic dispersion is measured as specified by the IEC 60793-1-42:2013 standard, “Optical fibres—Part 1-42: Measurement methods and test procedures—Chromatic dispersion.”

The cutoff wavelength of an optical fiber is the minimum wavelength at which the optical fiber will support only one propagating mode. For wavelengths below the cutoff wavelength, multimode transmission may occur and an additional source of dispersion may arise to limit the fiber's information carrying capacity. Cutoff wavelength will be reported herein as a cable cutoff wavelength. The cable cutoff wavelength is based on a 22-meter cabled fiber length as specified in TIA-455-80: FOTP-80 IEC-60793-1-44 Optical Fibres—Part 1-44: Measurement Methods and Test Procedures—Cut-off Wavelength (21 May 2003), by Telecommunications Industry Association (TIA).

The bend resistance of an optical fiber, expressed as “bend loss” herein, can be gauged by induced attenuation under prescribed test conditions as specified by the IEC-60793-1-47:2017 standard, “Optical fibres—Part 1-47: Measurement methods and test procedures—Macrobending loss.” For example, the test condition can entail deploying or wrapping the fiber one or more turns around a mandrel of a prescribed diameter, e.g., by wrapping 1 turn around either a 15 mm, 20 mm, or 30 mm or similar diameter mandrel (e.g. “1×15 mm diameter bend loss” or the “1×20 mm diameter bend loss” or the “1×30 mm diameter bend loss”) and measuring the increase in attenuation per turn.

The term “attenuation,” as used herein, is the loss of optical power as the signal travels along the optical fiber. Attenuation is measured as specified by the IEC 60793-1-40:2019 standard entitled “Optical fibers—Part 1-40: Attenuation measurement methods.”

The term “trench” as used herein, refers to a cladding region that has a variable refractive index with a minimum refractive index that is lower than that of the adjacent cladding regions that are in contact therewith. The trench region is down-doped with a suitable dopant such as fluorine.

The term “ring” as used herein, refers to a cladding region that has a variable refractive index with a maximum refractive index that is higher than that of the adjacent cladding regions that are in contact therewith. The ring region has a variable refractive index with a maximum refractive index that is greater than the variable refractive index of the adjacent trench region. The ring region is up-doped with a suitable dopant such as germania.

The mode field diameter (MFD) is measured using the Petermann II method and was determined from:

$$M F D = 2 w$$

$$w = \frac{{\int }_{0}^{∞} {( f ( r ) )}^{2}}{{\int }_{0}^{∞} {( \frac{d f ( r )}{d r} )}^{2} rdr}$$

where f(r) is the transverse component of the electric field distribution of the guided light and r is the radial position in the fiber. Unless otherwise specified, “mode field diameter” or “MFD” refers to the mode field diameter at 1310 nm.

Directional terms as used herein—for example up, down, right, left, front, back, top, bottom—are made only with reference to the figures as drawn and are not intended to imply absolute orientation.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used herein, the term “substantially free,” when used to describe the concentration and/or absence of a particular up-dopant or down-dopant in a particular portion of the fiber, means that the constituent component is not intentionally added to the fiber. However, the fiber may contain traces of the constituent component as a contaminant or trace in amounts of less than 0.15 wt. %.

As used herein, the singular forms “a,” “an” and “the” include plural referents unless the context clearly dictates otherwise. Thus, for example, reference to “a” component includes aspects having two or more such components, unless the context clearly indicates otherwise.

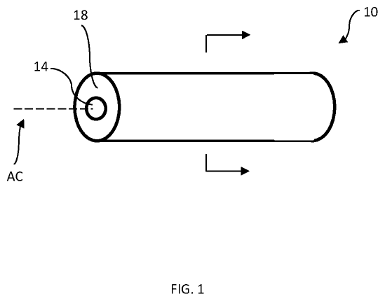

Referring now to FIG. 1, a side view of a single mode optical fiber 10 is provided. The optical fiber 10 has a centerline AC and a radial coordinate r. In embodiments, the optical fiber 10 has a germania doped silica central core 14 of radius r₁ surrounded by a cladding 18 having a maximum radius rₘₐₓ. The optical fiber 10 may have an outer radius for cladding 18 of rₘₐₓ=62.5 microns.

The core 14 has a core alpha profile (Core_{α}) where 1≤Core_{α}≤100 and a maximum relative refractive index delta Δ₁, where in embodiments Δ₁ is 0.25% to 0.50%, or preferably 0.3% to 0.45%. In embodiments, the core 14 has a radius r₁, where in embodiments r₁ is 3 μm to 5.5 μm or preferably 3.5 μm to 5 μm.

In embodiments, the core 14 can be made from silica doped with germania (Ge) at a Ge concentration of ≥4.5 wt %, 5.0 wt %, ≥5.5 wt %, ≥6.0 wt %, ≥6.5 wt %, or ≥7.0 wt %. In embodiments, the core 14 can be made from silica doped with germania (Ge) at a Ge concentration of 4.5 wt % to 7.0 wt %, or 5.0 wt % to 7.0 wt %, or 5.5 wt % to 7.0 wt %, or 6.0 wt % to 7.0 wt %, or 6.5 wt % to 7.0 wt %. In embodiments, the core 14 can be made from silica doped with chlorine (Cl) at the Ge concentrations described above. The single mode optical fiber 10 can include the germania doped silica central core 14 region where the core alpha profile (Core_{α}) is 1≤Core_{α}≤100. In embodiments, the core alpha profile (Core_{α}) is 1≤Core_{α}≤20. In embodiments, the core alpha profile (Core_{α}) is 1≤Core_{α}≤4.

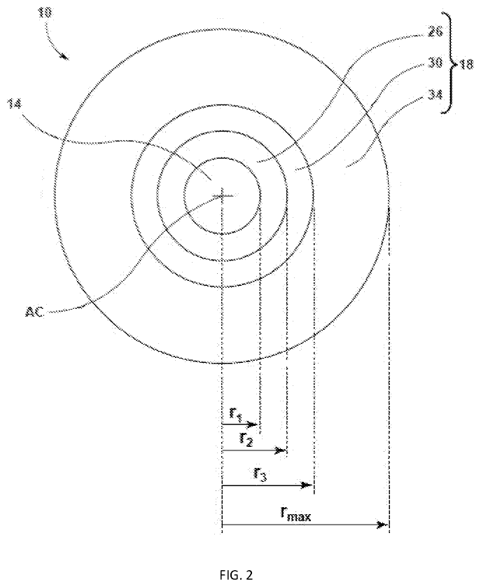

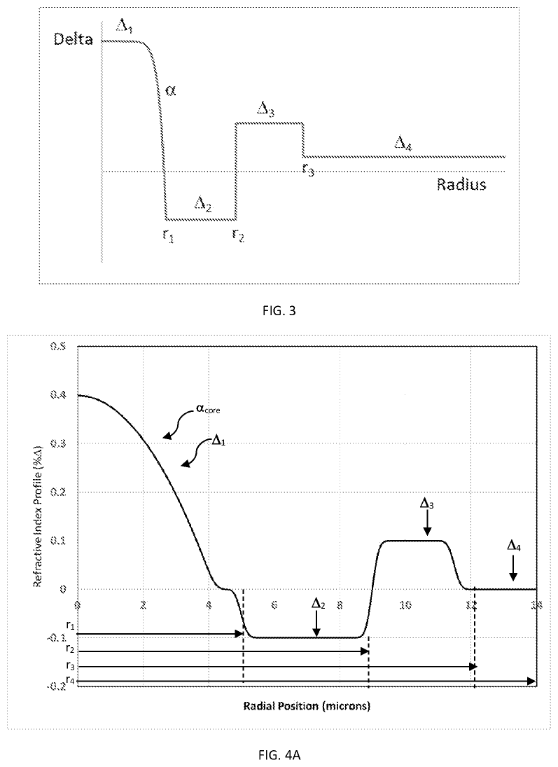

FIG. 2 depicts a schematic cross-sectional diagram of the optical fiber 10 according to embodiments of the current disclosure. In FIG. 3, a plot of the relative refractive index profile (“index profile”) A versus radius r for the optical fiber represented in FIG. 2 is shown. The cladding 18 of optical fiber 10 includes three regions that progress outwardly from the core 14 in the following order: the trench region 26 having the radius r₂ and the refractive index Δ₂; the ring region 30 surrounding the first cladding layer 26 extending to the radial distance r₃ and having the refractive index Δ₃; and the outer cladding region 34 having a radius rₘₐₓ and having the refractive index Δ₄. In embodiments, adjacent cladding regions are coupled with one another while the inner cladding region 26 is in contact with and coupled with the core 14. In embodiments, the inner cladding region 26 may be offset from the core region 14 by a cladding region (not shown) sandwiched between core region 14 and the inner cladding region 26.

In embodiments, the Δ₁ ranges from 0.25% to 0.50%, or preferably 0.3% to 0.45%. In embodiments, r₁ is 3 μm to 5.5 μm or preferably 3.5 μm to 5 μm.

In embodiments, the Δ₂ of the trench region ranges from −0.25% to 0.05%, or preferably from 0% to −0.2%. In embodiments, r₂ of the first inner cladding region is 6 μm to 12 μm, or preferably 6.5 μm to 10 μm.

The Δ₃ of the ring region is greater than the Δ₂ of the trench region. In embodiments, the Δ₃ of the ring region ranges from 0.02 to 0.2%, or preferably 0.05% to 0.15%. In embodiments, r₃ of the second inner cladding region 7 μm to 15 μm.

The Δ₄ of the outer cladding region is greater than the Δ₂ of the trench region and less than the Δ₃ of the ring region. In embodiments, the Δ₄ of the outer cladding region is 0.05 to 0.1%. In embodiments, r₄ (also referred to herein as rₘₐₓ) of the outer cladding region is 62.5 μm.

In embodiments, the optical fiber 10 may exhibit a chromatic dispersion slope at 1310 nm of less than or equal to 0.083 ps/nm²/km, or in embodiments less than or equal to 0.075 ps/nm²/km, or in embodiments less than or equal to 0.070 ps/nm²/km, or in embodiments less than or equal to 0.068 ps/nm²/km or in embodiments less than or equal to 0.0675 ps/nm²/km. In embodiments, the optical fiber 10 may exhibit a zero-dispersion wavelength 1o of less than 1400 nm, preferably less than 1390 nm, more preferably less than 1380 nm. In embodiments, the optical fiber 10 may exhibit a zero-dispersion wavelength λ₀ of 1300 nm to 1324 nm. In embodiments, the optical fiber 10 may exhibit an attenuation at 1310 nm and 1383 nm of less than 0.33 dB/km or preferably less than less than 0.32 dB/km. In embodiments, the optical fiber 10 may exhibit a mode field diameter (MFD) at 1310 nm of greater than 8.2 microns, or in embodiments greater than 8.5 microns, or in embodiments greater than 8.6 microns, or in embodiments greater than 9 microns. In embodiments, the optical fiber 10 may exhibit a 22 mm cable cut-off less than or equal to 1260 nm. In embodiments, the optical fiber 10 may exhibit a chromatic dispersion at 1310 nm of greater than −7 ps/nm/km, preferably greater than −6 ps/nm/km. In embodiments, the optical fiber 10 exhibits a chromatic dispersion at 1380 nm of less than 5 ps/nm/km. In embodiments, the optical fiber 10 exhibits a chromatic dispersion at 1260 nm of greater than −10 ps/nm/km.

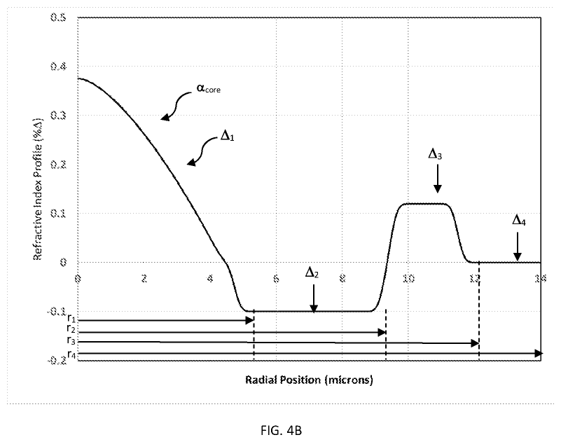

Table 1, Table 2, and Table 3 below sets forth examples of the embodiments used in the optical fiber 10. FIG. 4A depicts a plot of the relative refractive index profile (“index profile”) Δ versus radius r for the optical fiber represented in Example 19 of Table 3. FIG. 4B depicts a plot of the relative refractive index profile (“index profile”) Δ versus radius r for the optical fiber represented in Example 21 of Table 3. FIG. 4C depicts a plot of the relative refractive index profile (“index profile”) A versus radius r for the optical fiber represented in Example 23 of Table 3. The inventive examples shown in Table 1 have mode field diameter at 1310 nm of greater than 8.2 microns, cable cutoff of less than 1260 nm, zero dispersion wavelength between 1300 nm and 1324 nm and dispersion slope at 1310 nm of less than 0.083 ps/nm²/km. The dispersion at 1310 nm is greater than −7 ps/nm/km. In embodiments, the mode field diameter at 1310 nm is greater than 8.6 microns. In other embodiments, the mode field diameter at 1310 nm is greater than 8.6 microns. The inventive examples shown in Tables 2 and 3 have mode field diameter at 1310 nm of greater than 8.2 microns, cable cutoff of less than 1260 nm, zero dispersion wavelength of less than 1400 nm and dispersion slope at 1310 nm of less than 0.083 ps/nm²/km. In embodiments, the slope is less than 0.07 ps/nm²/km. In other embodiments, the slope is less than 0.07 ps/nm²/km. In embodiments, the MVFD at 1310 nm is greater than 8.6 microns. In other embodiments, the MVFD at 1310 nm is greater than 9 microns. In embodiments, the zero dispersion wavelength is less than 1390 nm. In other embodiments, the zero dispersion wavelength is less than 1380 nm.

TABLE 1

| | Ex.1 | Ex.2 | Ex.3 | Ex.4 | Ex.5 | Ex.6 | Ex.7 | Ex.8 | Ex.9 |
|---|---|---|---|---|---|---|---|---|---|
| Δ₁ | 0.29 | 0.32 | 0.34 | 0.4 | 0.365 | 0.365 | 0.36 | 0.42 | 0.365 |
| α | 10 | 10 | 10 | 10 | 10 | 10 | 10 | 10 | 10 |
| r₁ | 4.7 | 4.9 | 5 | 4.7 | 4.8 | 4.8 | 4.7 | 4.9 | 4.8 |
| Δ₂ | −0.09 | −0.1 | −0.2 | 0 | 0 | 0 | 0 | 0 | 0 |
| r₂ | 9 | 7 | 7 | 8 | 8.5 | 8.5 | 8.5 | 7 | 8.5 |
| Δ₃ | 0.1 | 0.05 | 0.15 | 0.15 | 0.1 | 0.1 | 0.1 | 0.15 | 0.12 |
| r₃ | 12 | 11 | 9.5 | 12 | 14 | 14 | 12 | 11 | 14 |
| Δ₄ | 0 | 0 | 0 | 0.08 | 0.05 | 0.03 | 0.03 | 0.1 | 0.03 |
| Ring Volume | 6.3 | 3.6 | 6.2 | 5.6 | 6.2 | 8.7 | 5.0 | 3.6 | 11.1 |
| (μm² · %Δ) | | | | | | | | | |
| Cable cutoff | 1037.9 | 1189.8 | 1185.2 | 1087.2 | 1137.2 | 1219.6 | 1220.6 | 1152.3 | 1199.9 |
| wavelength | | | | | | | | | |
| (nm) | | | | | | | | | |
| MFD at 1310 | 9.1 | 9.1 | 8.9 | 8.9 | 9.2 | 9.1 | 9.1 | 9.0 | 9.2 |
| nm (μm) | | | | | | | | | |
| Effective area | 65.4 | 66.5 | 64.2 | 63.0 | 66.6 | 66.0 | 65.2 | 64.8 | 67.0 |
| at 1310 nm | | | | | | | | | |
| (μm²) | | | | | | | | | |
| MFD at 1550 | 10.5 | 10.4 | 10.1 | 10.3 | 10.5 | 10.4 | 10.4 | 10.3 | 10.6 |
| nm (μm) | | | | | | | | | |
| Effective area | 84.6 | 83.7 | 80.2 | 81.5 | 85.0 | 83.6 | 83.1 | 82.3 | 86.5 |
| at 1550 nm | | | | | | | | | |
| (μm²) | | | | | | | | | |
| Zero- | 1312.8 | 1308.4 | 1305.8 | 1319.2 | 1311.4 | 1311.2 | 1314.5 | 1316.3 | 1314.7 |
| dispersion | | | | | | | | | |
| wavelength | | | | | | | | | |
| (ma) | | | | | | | | | |
| Dispersion | 0.0789 | 0.0829 | 0.0817 | 0.0788 | 0.0827 | 0.083 | 0.08239 | 0.0813 | 0.0811 |
| slope | | | | | | | | | |
| (ps/nm²/km) | | | | | | | | | |
| Dispersion at | −1.02 | −0.69 | −0.46 | −1.69 | −1.09 | −0.93 | −1.21 | −1.34 | −1.36 |
| 1300 nm | | | | | | | | | |
| (ps/nm/km) | | | | | | | | | |
| Dispersion | 0.0817 | 0.0845 | 0.0828 | 0.0826 | 0.0849 | 0.0853 | 0.0853 | 0.0845 | 0.0838 |
| slope at 1300 | | | | | | | | | |
| nm | | | | | | | | | |
| (ps/nm²/km) | | | | | | | | | |
| Dispersion at | −0.21 | 0.14 | 0.35 | −0.88 | −0.25 | −0.09 | −0.37 | −0.51 | −0.53 |
| 1310 nm | | | | | | | | | |
| (ps/nm/km) | | | | | | | | | |
| Dispersion | 0.0795 | 0.0825 | 0.0808 | 0.0805 | 0.0828 | 0.0832 | 0.0833 | 0.0825 | 0.0818 |
| slope at 1310 | | | | | | | | | |
| nm | | | | | | | | | |
| (ps/nm²/km) | | | | | | | | | |
| Dispersion at | 0.88 | 1.28 | 1.46 | 0.23 | 0.89 | 1.06 | 0.78 | 0.63 | 0.59 |
| 1324 nm | | | | | | | | | |
| (ps/nm/km) | | | | | | | | | |
| Dispersion | 0.0766 | 0.0799 | 0.0781 | 0.0777 | 0.0801 | 0.0805 | 0.0806 | 0.0798 | 0.0790 |
| slope at 1324 | | | | | | | | | |
| nm | | | | | | | | | |
| (ps/nm²/km) | | | | | | | | | |
| Dispersion at | 14.35 | 15.91 | 15.69 | 14.16 | 15.37 | 15.67 | 15.52 | 15.19 | 14.89 |
| 1550 nm | | | | | | | | | |
| (ps/nm/km) | | | | | | | | | |
| Dispersion | 0.048 | 0.054 | 0.053 | 0.051 | 0.053 | 0.053 | 0.054 | 0.054 | 0.052 |
| slope at 1550 | | | | | | | | | |
| nm | | | | | | | | | |
| (ps/nm²/km) | | | | | | | | | |
| Dispersion at | −3.57 | −3.32 | −3.05 | −4.128 | −3.602 | −3.59 | −3.87 | −3.97 | −3.8302 |
| 1270 | | | | | | | | | |
| (ps/nm/km) | | | | | | | | | |
| Dispersion at | 1.34 | 1.75 | 1.93 | 0.848 | 1.513 | 1.54 | 1.26 | 1.11 | 1.2251 |
| 1330 | | | | | | | | | |
| (ps/nm/km) | | | | | | | | | |
| Dispersion at | −4.47 | −4.25 | −3.95 | −5.038 | −4.533 | −4.52 | −4.80 | −4.90 | −4.7515 |
| 1260 | | | | | | | | | |
| (ps/nm/km) | | | | | | | | | |
| Dispersion at | 4.88 | 5.49 | 5.57 | 4.464 | 5.254 | 5.29 | 5.02 | 4.83 | 4.91388 |
| 1380 | | | | | | | | | |
| (ps/nm/km) | | | | | | | | | |
| 1550 nm | <0.00001 | <0.00001 | <0.00001 | <0.00001 | <0.00001 | <0.00001 | <0.00001 | <0.00001 | <0.00001 |
| 60 mm | | | | | | | | | |
| bend loss | | | | | | | | | |
| (dB/turn) | | | | | | | | | |
| 1625 nm | 0.00810 | <0.00001 | 0.00022 | 0.00410 | 0.00310 | 0.00047 | 0.00330 | 0.00016 | <0.00001 |
| 60 mm | | | | | | | | | |
| bend loss | | | | | | | | | |
| (dB/turn) | | | | | | | | | |

TABLE 2

| | Ex.10 | Ex.11 | Ex.12 | Ex.13 | Ex.14 | Ex.15 | Ex.16 | Ex.17 | Ex.18 |
|---|---|---|---|---|---|---|---|---|---|
| Δ₁ | 0.4 | 0.41 | 0.36 | 0.42 | 0.43 | 0.38 | 0.335 | 0.45 | 0.45 |
| α | 10 | 2.5 | 2.5 | 3.5 | 2.5 | 2.5 | 10 | 12 | 12 |
| r₁ | 3.885 | 4.97 | 4.8 | 4.45 | 4.9 | 4.85 | 4.2 | 3.3 | 3.55 |
| Δ₂ | 0 | −0.05 | −0.1 | 0 | 0 | −0.05 | 0 | 0 | 0 |
| r₂ | 8 | 7.5 | 7.5 | 8 | 8 | 8 | 9 | N/A | N/A |
| Δ₃ | 0.075 | 0.1 | 0.05 | 0.075 | 0.1 | 0.075 | 0.1 | 0 | 0 |
| r₃ | 14 | 14 | 14 | 14 | 14 | 14 | 15 | N/A | N/A |
| Δ₄ | 0 | 0 | 0 | 0 | 0 | 0 | 0 | 0 | 0 |
| Ring Volume | 9.9 | 14.0 | 7.0 | 9.9 | 13.2 | 9.9 | 14.4 | | |
| (μm² · %Δ) | | | | | | | | | |
| Cable cutoff | 1132.0 | 1093.0 | 962.6 | 1144.5 | 1173.0 | 1029.3 | 1103.6 | 999.5 | 1035.0 |
| wavelength (nm) | | | | | | | | | |
| MFD at 1310 | 8.3 | 8.6 | 8.6 | 8.4 | 8.6 | 8.7 | 9.1 | 7.6 | 7.7 |
| nm (mm) | | | | | | | | | |
| Effective area at | 52.5 | 56.3 | 56.4 | 53.2 | 55.8 | 57.5 | 63.0 | 43.6 | 45.4 |
| 1310 nm (mm²) | | | | | | | | | |
| MFD at 1550 | 9.8 | 10.2 | 10.2 | 9.9 | 10.2 | 10.4 | 10.9 | 8.9 | 8.9 |
| nm (mm) | | | | | | | | | |
| Effective area at | 71.0 | 78.5 | 78.8 | 72.5 | 77.2 | 80.6 | 89.2 | 59.3 | 59.43 |
| 1550 nm (mm²) | | | | | | | | | |
| Zero-dispersion | 1354.4 | 1355.2 | 1351.7 | 1354.6 | 1355.7 | 1554.2 | 1352.9 | 1381.7 | 1353.4 |
| wavelength (nm) | | | | | | | | | |
| Dispersion slope | 0.0706 | 0.0693 | 0.0682 | 0.0726 | 0.0724 | 0.06998 | 0.069 | 0.06897 | 0.0740 |
| (ps/nm²/km) | | | | | | | | | |
| Dispersion at | −4.10 | −4.10 | −3.78 | −4.22 | −4.30 | −4.06 | −3.89 | −6.13 | −4.1900 |
| 1300 nm | | | | | | | | | |
| (ps/nm/km) | | | | | | | | | |
| Dispersion slope | 0.0807 | 0.0800 | 0.0788 | 0.0827 | 0.0827 | 0.0805 | 0.0790 | 0.0820 | 0.08 |
| at 1300 nm | | | | | | | | | |
| (ps/nm²/km) | | | | | | | | | |
| Dispersion at | −3.30 | −3.07 | −3.00 | −3.40 | −3.48 | −3.26 | −3.11 | −5.32 | −3.3670 |
| 1310 nm | | | | | | | | | |
| (ps/nm/km) | | | | | | | | | |
| Dispersion slope | 0.0786 | 0.0778 | 0.0766 | 0.0806 | 0.0807 | 0.0784 | 0.0769 | 0.0801 | 0.08 |
| at 1310 nm | | | | | | | | | |
| (ps/nm²/km) | | | | | | | | | |
| Dispersion at | −2.22 | −2.24 | −1.95 | −2.29 | −2.37 | −2.19 | −2.06 | −4.21 | −2.24 |
| 1324 nm | | | | | | | | | |
| (ps/nm/km) | | | | | | | | | |
| Dispersion slope | 0.08 | 0.08 | 0.07 | 0.08 | 0.08 | 0.08 | 0.07 | 0.08 | 0.08 |
| at 1324 nm | | | | | | | | | |
| (ps/nm²/km) | | | | | | | | | |
| Dispersion at | 11.54 | 11.23 | 10.86 | 11.91 | 11.86 | 11.34 | 11.35 | 10.20 | 12.328 |
| 1550 nm | | | | | | | | | |
| (ps/nm/km) | | | | | | | | | |
| Dispersion slope | 0.0511 | 0.0504 | 0.0456 | 0.0529 | 0.0536 | 0.0500 | 0.0509 | 0.0543 | 0.0543 |
| at 1550 nm | | | | | | | | | |
| (ps/nm²/km) | | | | | | | | | |
| Dispersion at | −6.62 | −6.60 | −6.25 | −6.79 | −6.88 | −6.58 | −6.27 | −8.68 | −6.79 |
| 1270 nm | | | | | | | | | |
| (ps/nm/km) | | | | | | | | | |
| Dispersion at | −1.77 | −1.79 | −1.52 | −1.83 | −1.91 | −1.74 | −1.62 | −3.75 | −1.77 |
| 1330 nm | | | | | | | | | |
| (ps/nm/km) | | | | | | | | | |
| Dispersion at | −7.50 | −7.48 | −7.12 | −7.70 | −7.79 | −7.47 | −7.24 | −9.57 | −7.7 |
| 1260 nm | | | | | | | | | |
| (ps/nm/km) | | | | | | | | | |
| Dispersion at | 1.76 | 1.68 | 1.87 | 1.81 | 1.72 | 1.76 | 1.82 | −0.11 | 1.926 |
| 1380 nm | | | | | | | | | |
| (ps/nm/km) | | | | | | | | | |
| 1550 nm | <0.00001 | <0.00001 | <0.00001 | <0.00001 | <0.00001 | <0.00001 | <0.00001 | <0.00001 | <0.00001 |
| 60 mm | | | | | | | | | |
| bend loss | | | | | | | | | |
| (dB/turn) | | | | | | | | | |
| 1625 nm | <0.00001 | 0.05000 | 0.06200 | <0.00001 | <0.00001 | 0.04500 | 0.19500 | 0.00003 | <0.00001 |
| 60 mm | | | | | | | | | |
| bend loss | | | | | | | | | |
| (dB/turn) | | | | | | | | | |

TABLE 3

| | Ex 19 | Ex 20 | Ex 21 | Ex 22 | Ex 23 |
|---|---|---|---|---|---|
| Δ₁ (%) | 0.4 | 0.38 | 0.38 | 0.38 | 0.38 |
| r₁ (microns) | 4.2 | 4.2 | 4.4 | 4.2 | 4.6 |
| Core Alpha | 2 | 2 | 1.5 | 1.75 | 1.25 |
| Δ₂ (%) | −0.1 | −0.1 | −0.1 | −0.1 | −0.1 |
| r₂ (microns) | 9 | 9.5 | 9.5 | 9.5 | 9.5 |
| Δ₃ (%) | 0.1 | 0.12 | 0.12 | 0.12 | 0.12 |
| r₃ (microns) | 11.5 | 11.5 | 11.5 | 11.5 | 11.5 |
| Δ₄ (%) | 0 | 0 | 0 | 0 | 0 |
| Dispersion at 1310 nm (ps/nm/km) | −5 | −5.18 | −6.03 | −6.06 | −6.42 |
| Dispersion at 1550 nm (ps/nm/km) | 7.96 | 6.69 | 4.86 | 4.86 | 4.11 |
| Dispersion Slope at 1310 nm (ps/nm²/km) | 0.0746 | 0.0731 | 0.0693 | 0.07 | 0.067 |
| Dispersion Slope at 1550 nm (ps/nm²/km) | 0.0388 | 0.0323 | 0.0303 | 0.0294 | 0.033 |
| MFD at 1310 nm (microns) | 8.3 | 8.39 | 8.69 | 8.53 | 8.94 |
| Effective Area at 1310 nm (micron²) | 51.67 | 52.84 | 56.51 | 54.37 | 11.53 |
| LP11 cutoff (nm) | 1081 | 1064 | 1062 | 1061 | 1062 |
| LP02 cutof (nm) | 1374 | 1355 | 1338 | 1345 | 1327 |
| Cable Cutoff (nm) | 1240 | 1224 | 1207 | 1214 | 1196 |
| Attenuation at 1310 nm (dB/km) | <0.32 | <0.32 | <0.32 | <0.32 | <0.32 |
| Attenuation at 1383 nm (dB/km) | <0.32 | <0.32 | <0.32 | <0.32 | <0.32 |

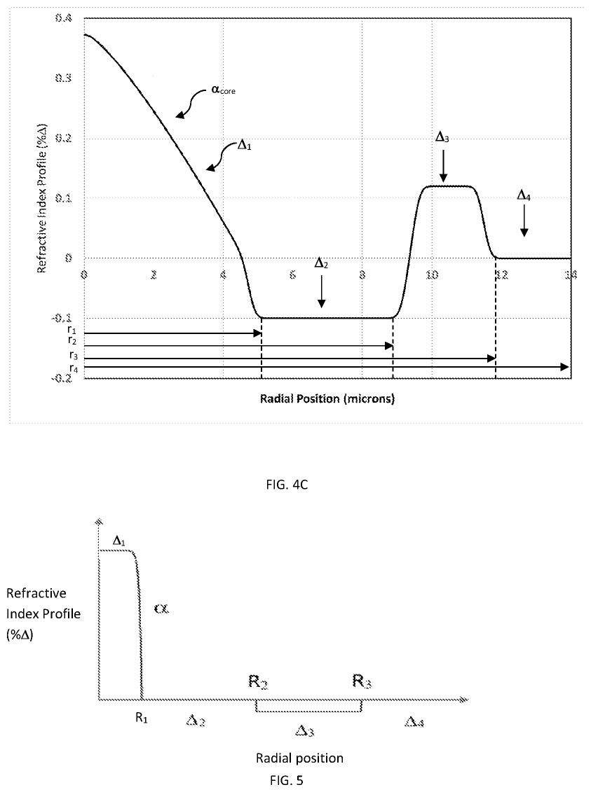

Table 4 below sets forth examples of further embodiments of an optical fiber in accordance with the current description. FIG. 5 graphically depicts an exemplary relative refractive index profile of exemplary optical fibers, according to one or more embodiments described herein. FIG. 5 shows a schematic of a fiber profile design with up to four segments. An exemplary optical fiber having profile design as depicted in FIG. 5 includes a core portion having a relative refractive index of Ai and a radius R₁, and a cladding portion. In embodiments, the cladding portion includes an inner cladding region having a relative refractive index of Δ₂ that is substantially zero (i.e. silica glass) and a radius R₂, a down-doped trench region having a relative refractive index of Δ₃ and a radius R₃, which can extend to the edge of the cladding potion, and an outer cladding region if the down-doped trench region does not extend to the edge of the cladding portion. The outer cladding region having a relative refractive index of Δ₄. In embodiments, the cladding portion includes an inner cladding region that is up-doped having a relative refractive index of Δ₂ and a radius R₂, a silica cladding region having a relative refractive index of Δ₃ that is substantially zero and a radius R₃, which can extend to the edge of the cladding potion, and an outer cladding region if the silica cladding region does not extend to the edge of the cladding portion. The outer cladding region having a relative refractive index of Δ₄.

TABLE 4

| | Ex.24 | Ex.25 | Ex.26 | Ex.27 | Ex.28 | Ex.29a |
|---|---|---|---|---|---|---|
| Δ₁ | 0.32 | 0.32 | 0.32 | 0.32 | 0.32 | 0.318 |
| α | 20 | 20 | 20 | 15 | 10 | 8 |
| r₁ | 4.06 | 4.06 | 4.06 | 4.1 | 4.2 | 4.34 |
| Δ₂ | n/a | 0 | 0 | 0 | 0 | 0 |
| r₂ | n/a | 11 | 11 | 12 | 12 | 12 |
| Δ₃ | n/a | −0.03 | −0.03 | −0.03 | −0.03 | −0.03 |
| r₃ | n/a | 62.5 | 25 | 62.5 | 62.5 | 62.5 |
| Δ₄ | 0 | n/a | 0 | 0 | 0 | 0 |
| Cable cutoff | 1032 | 1113 | 1102 | 1101 | 1114 | 1118 |
| (nm) | | | | | | |
| MFD at | 9.1 | 9.06 | 9.06 | 9.1 | 9.1 | 9.2 |
| 1310 nm | | | | | | |
| (mm) | | | | | | |
| Effective | 63.5 | 63.4 | 63.4 | 63.3 | 63.4 | 64.4 |
| area at 1310 | | | | | | |
| run (mm²) | | | | | | |
| MFD at | 10.5 | 10.5 | 10.5 | 10.5 | 10.6 | 10.6 |
| 1550 nm | | | | | | |
| (mm) | | | | | | |
| Effective | 83.2 | 82.6 | 82.6 | 82.9 | 83.4 | 84.6 |
| area at 1550 | | | | | | |
| run (mm²) | | | | | | |
| Zero- | 1327.6 | 1326 | 1326 | 1328 | 1329 | 1327 |
| dispersion | | | | | | |
| wavelength | | | | | | |
| (nm) | | | | | | |
| Dispersion | 0.0813 | 0.0823 | 0.0823 | 0.0818 | 0.0817 | 0.0824 |
| slope | | | | | | |
| (ps/nm²/km) | | | | | | |
| Dispersion | −1.45 | −1.34 | −1.34 | −1.503 | −1.6 | −1.43 |
| at 1310 nm | | | | | | |
| (ps/nm/km) | | | | | | |
| Dispersion | 0.084 | 0.852 | 0.0852 | 0.085 | 0.0851 | 0.0854 |
| slope at | | | | | | |
| 1310 nm | | | | | | |
| (ps/nm²/km) | | | | | | |
| Dispersion | 14.95 | 15.34 | 15.34 | 15.133 | 15.068 | 15.313 |
| at 1550 nm | | | | | | |
| (ps/nm/km) | | | | | | |
| Dispersion | 0.057 | 0.0588 | 0.0588 | 0.0586 | 0.0588 | 0.059 |
| slope at | | | | | | |
| 1550 nm | | | | | | |
| (ps/nm²/km) | | | | | | |
| Dispersion | −5.93 | −5.848 | −5.84 | −5.999 | −6.114 | −5.954 |
| at 1260 nm | | | | | | |
| (ps/nm/km) | | | | | | |
| Dispersion | 2.553 | 2.707 | 2.707 | 0.085 | 2.433 | 2.628 |
| at 1360 nm | | | | | | |
| (ps/nm/km) | | | | | | |
| Dispersion | 3.826 | 3.996 | 3.996 | 3.818 | 3.72 | 3.921 |
| at 1377 nm | | | | | | |
| (ps/nm/km) | | | | | | |
| Dispersion | 5.485 | 5.678 | 5.678 | 5.494 | 5.4 | 5.609 |
| at 1400 nm | | | | | | |
| (ps/nm/km) | | | | | | |
| 1550 nm | 1.50E−03 | 7.19E−05 | 7.19E−05 | 1.52E−04 | 4.24E−04 | 5.19E−04 |
| 50 mm | | | | | | |
| bend loss | | | | | | |
| (dB/turn) | | | | | | |
| 1550 nm | 3.40E−04 | 2.91E−07 | 2.91E−07 | 4.37E−04 | 7.45E−07 | 8.48E−07 |
| 60 mm | | | | | | |
| bend loss | | | | | | |
| (dB/turn) | | | | | | |
| 1625 nm | 1.82E−02 | 6.58E−06 | 6.58E−06 | 1.01E−03 | 1.78E−05 | 1.97E−05 |
| 60 mm | | | | | | |
| bend loss | | | | | | |
| (dB/turn) | | | | | | |
| | Ex.29b | Ex.29c | Ex.30 | Ex.31 | Ex.32 | Ex.33 |
| Δ₁ | 0.318 | 0.348 | 0.0335 | 0.345 | 0.35 | 0.37 |
| α | 8 | 8 | 7 | 5 | 3 | 2.6 |
| r₁ | 4.34 | 4.34 | 4.35 | 4.5 | 4.95 | 5.1 |
| Δ₂ | 0 | 0.03 | 0 | 0 | 0 | 0 |
| r₂ | 12 | 12 | 12 | 11 | 11 | 11 |
| Δ₃ | −0.04 | 0 | −0.02 | −0.02 | −0.02 | −0.02 |
| r₃ | 62.5 | 62.5 | 62.5 | 62.5 | 62.5 | 62.5 |
| Δ₄ | 0 | 0 | 0 | 0 | 0 | 0 |
| Cable cutoff | 1167 | 1120 | 1093 | 1098 | 1095 | 1126 |
| (nm) | | | | | | |
| MFD at | 9.2 | 9.2 | 8.98 | 8.94 | 9.2 | 9.1 |
| 1310 nm | | | | | | |
| (mm) | | | | | | |
| Effective | 64.4 | 64.7 | 61.93 | 61.16 | 63.4 | 62 |
| area at 1310 | | | | | | |
| run (mm²) | | | | | | |
| MFD at | 10.6 | 10.7 | 10.4 | 10.4 | 10.6 | 10.5 |
| 1550 nm | | | | | | |
| (mm) | | | | | | |
| Effective | 84.5 | 85.2 | 81.1 | 80.2 | 83.7 | 81.4 |
| area at 1550 | | | | | | |
| run (mm²) | | | | | | |
| Zero- | 1327 | 1328.7 | 1328.1 | 1329 | 1328.2 | 1327.2 |
| dispersion | | | | | | |
| wavelength | | | | | | |
| (nm) | | | | | | |
| Dispersion | 0.083 | 0.0824 | 0.082 | 0.082 | 0.084 | 0.084 |
| slope | | | | | | |
| (ps/nm²/km) | | | | | | |
| Dispersion | −1.41 | −1.562 | −1.502 | −1.59 | −1.545 | −1.473 |
| at 1310 nm | | | | | | |
| (ps/nm/km) | | | | | | |
| Dispersion | 0.0856 | 0.0857 | 0.085 | 0.0856 | 0.087 | 0.087 |
| slope at | | | | | | |
| 1310 nm | | | | | | |
| (ps/nm²/km) | | | | | | |
| Dispersion | 15.395 | 15.249 | 15.12 | 15.14 | 15.47 | 15.6 |
| at 1550 nm | | | | | | |
| (ps/nm/km) | | | | | | |
| Dispersion | 0.0594 | 0.0593 | 0.058 | 0.059 | 0.0597 | 0.06 |
| slope at | | | | | | |
| 1550 nm | | | | | | |
| (ps/nm²/km) | | | | | | |
| Dispersion | −5.939 | −6.098 | −6.01 | −6.12 | −6.148 | −6.1 |
| at 1260 nm | | | | | | |
| (ps/nm/km) | | | | | | |
| Dispersion | 2.658 | 2.512 | 2.542 | 2.477 | 2.588 | 2.681 |
| at 1360 nm | | | | | | |
| (ps/nm/km) | | | | | | |
| Dispersion | 3.954 | 3.81 | 3.828 | 3.772 | 3.904 | 4.003 |
| at 1377 nm | | | | | | |
| (ps/nm/km) | | | | | | |
| Dispersion | 5.647 | 5.504 | 5.506 | 5.46 | 5.62 | 5.728 |
| at 1400 nm | | | | | | |
| (ps/nm/km) | | | | | | |
| 1550 nm | 1.27E−05 | 9.63E−04 | 2.55E−04 | 1.25E−04 | 6.76E−04 | 1.26E−07 |
| 50 mm | | | | | | |
| bend loss | | | | | | |
| (dB/turn) | | | | | | |
| 1550 nm | 1.21E−07 | 1.35E−06 | 5.40E−07 | 3.65E−07 | 9.56E−07 | 1.33E−07 |
| 60 mm | | | | | | |
| bend loss | | | | | | |
| (dB/turn) | | | | | | |
| 1625 nm | 2.35E−06 | 3.30E−05 | 1.34E−05 | 8.95E−06 | 2.33E−05 | 2.85E−06 |
| 60 mm | | | | | | |
| bend loss | | | | | | |
| (dB/turn) | | | | | | |

Tables 5A-5D below set forth examples of further embodiments of an optical fiber in accordance with the current description. Embodiments of fibers set forth in Tables 5A-5D comprise (i) a graded index core having an alpha of 1 to 4, a maximum relative refractive index of 0.35% to 0.55% and a radius between 3.5 and 5.0 microns, (ii) a depressed index ring surrounding the core, which is offset from the core in embodiments, and has a relative refractive index of −0.2% to −0.05% and a width of 1.5 microns to 3.5 microns, and (iii) a raised index ring, surrounding the depressed index ring, with a delta of 0.05% to 0.15%, a radius of 5.5 microns to 7.0 microns, and a width of 1.0 microns to 3.0 microns. In embodiments, the core is a Ge-doped core. In embodiments, the trench is fluorine doped. In embodiments, the optical fiber exhibits dispersion at 1360 nm of less than 3 ps/nm/km, or less than 2 ps/nm/km, or less than 1 ps/nm/km, or less than 0 ps/nm/km. In embodiments, the optical fiber exhibits dispersion at 1260 nm of greater than −10 ps/nm/km, or greater than −9 ps/nm/km, or greater than −8 ps/nm/km, or greater than −7 ps/nm/km. In embodiments, the optical fiber exhibits pin array bend loss at 1310 nm of less than 4 dB, or less than 3 dB, or less than 2 dB, or is less than 1 dB. In embodiments, the optical fiber exhibits pin array bend loss at 1360 nm of less than 10 dB, or less than 8 dB, or less than 6 dB, or less than 4 dB. In embodiments, the optical fiber exhibits cable cutoff wavelength of less than 1260 nm, or less than 1200 nm, or less than 1100 nm, or less than 1060 nm. In embodiments, the optical fiber exhibits nominal MFD at 1310 nm of between 7.2 and 8.6 microns. The MFD of the optical fiber embodiments set forth in Tables 5A-5D can be expanded to a value of 8.6 microns or larger either by splicing or prior to connectorization. In embodiments, the MFD at 1310 nm may be expanded to a value of 8.6 microns to 9.6 microns.

TABLE 5A

| Example | 34 | 35 | 36 | 37 | 38 | 39 | 40 | 41 | 42 |
|---|---|---|---|---|---|---|---|---|---|
| D0 (%) | 0.38 | 0.5 | 0.38 | 0.38 | 0.38 | 0.38 | 0.42 | 0.38 | 0.38 |
| D1 (%) | 0.410 | 0.500 | 0.450 | 0.450 | 0.424 | 0.423 | 0.447 | 0.432 | 0.440 |
| R1 (microns) | 4.55 | 3.73 | 4.41 | 3.99 | 4.13 | 4.44 | 4.37 | 4.30 | 4.11 |
| Alpha | 2.21 | 2.31 | 1.89 | 2.89 | 2.48 | 2.30 | 2.73 | 2.43 | 2.46 |
| D2 (%) | −0.150 | −0.148 | −0.164 | −0.130 | −0.121 | −0.182 | −0.168 | −0.169 | −0.128 |
| R2 (microns) | 6.24 | 5.89 | 6.07 | 6.26 | 6.56 | 6.16 | 5.87 | 6.34 | 5.89 |
| W2 (microns) | 1.95 | 1.82 | 2.19 | 2.11 | 1.87 | 1.78 | 1.98 | 1.96 | 2.10 |
| D3 (%) | 0.093 | 0.089 | 0.106 | 0.092 | 0.107 | 0.087 | 0.078 | 0.084 | 0.086 |
| R3 (microns) | 9.56 | 9.25 | 9.24 | 9.75 | 9.10 | 9.12 | 9.32 | 9.33 | 9.39 |
| W3 (microns) | 2.13 | 2.17 | 1.65 | 1.50 | 1.73 | 2.26 | 2.08 | 2.83 | 2.56 |

TABLE 5B

| Example | 43 | 44 | 45 | 46 | 47 | 48 | 49 | 50 | 51 |
|---|---|---|---|---|---|---|---|---|---|
| Δ0 (%) | 0.39 | 0.39 | 0.39 | 0.39 | 0.39 | 0.39 | 0.39 | 0.39 | 0.39 |
| Δ1 (%) | 0.461 | 0.419 | 0.414 | 0.424 | 0.382 | 0.393 | 0.383 | 0.440 | 0.422 |
| R1 (microns) | 3.88 | 4.20 | 4.15 | 4.32 | 4.73 | 4.62 | 4.45 | 4.34 | 4.47 |
| Alpha | 2.62 | 2.48 | 3.02 | 2.21 | 2.50 | 2.60 | 3.07 | 2.67 | 2.54 |
| Δ2 (%) | −0.099 | −0.078 | −0.090 | −0.096 | −0.100 | −0.122 | −0.088 | −0.097 | −0.107 |
| R2 (microns) | 6.28 | 6.46 | 5.97 | 6.33 | 6.66 | 6.57 | 6.55 | 6.53 | 6.56 |
| W2 (microns) | 2.29 | 2.51 | 2.62 | 2.73 | 2.67 | 2.19 | 2.88 | 3.01 | 2.59 |
| Δ3 (%) | 0.089 | 0.079 | 0.091 | 0.089 | 0.093 | 0.087 | 0.089 | 0.090 | 0.092 |
| R3 (microns) | 9.89 | 9.81 | 10.41 | 10.07 | 10.23 | 9.75 | 10.26 | 10.40 | 10.17 |
| W3 (microns) | 2.08 | 2.00 | 1.55 | 2.33 | 2.02 | 2.17 | 2.00 | 2.00 | 2.20 |

TABLE 5C

| Example | 34 | 35 | 36 | 37 | 38 | 39 | 40 | 41 | 42 |
|---|---|---|---|---|---|---|---|---|---|
| Dispersion 1260 | −6.85 | −9.86 | −7.31 | −7.53 | −8.31 | −6.80 | −6.06 | −7.03 | −8.31 |
| nm (ps/nm/km) | | | | | | | | | |
| Dispersion 1310 | −2.60 | −5.80 | −3.09 | −3.25 | −4.05 | −2.56 | −1.79 | −2.78 | −4.22 |
| nm (ps/nm/km) | | | | | | | | | |
| Dispersion 1330 | −1.05 | −4.34 | −1.57 | −1.69 | −2.50 | −1.03 | −0.24 | −1.24 | −2.75 |
| nm (ps/nm/km) | | | | | | | | | |
| Dispersion 1360 | 1.12 | −2.30 | 0.56 | 0.50 | −0.31 | 1.13 | 1.94 | 0.92 | −0.69 |
| nm (ps/nm/km) | | | | | | | | | |
| Dispersion 1550 | 11.87 | 7.54 | 10.91 | 11.32 | 10.74 | 11.76 | 12.65 | 11.52 | 9.42 |
| nm (ps/nm/km) | | | | | | | | | |
| Slope 1310 nm | 0.079 | 0.075 | 0.078 | 0.080 | 0.080 | 0.079 | 0.080 | 0.079 | 0.076 |
| (ps/nm²/km) | | | | | | | | | |
| Slope 1360 nm | 0.070 | 0.065 | 0.068 | 0.070 | 0.070 | 0.069 | 0.070 | 0.069 | 0.066 |
| (ps/nm²/km) | | | | | | | | | |
| Slope 1550 nm | 0.047 | 0.043 | 0.044 | 0.047 | 0.050 | 0.046 | 0.046 | 0.045 | 0.045 |
| (ps/nm²/km) | | | | | | | | | |
| Zero Dispersion | 1344 | 1395 | 1352 | 1353 | 1364 | 1344 | 1332 | 1347 | 1370 |
| (nm) | | | | | | | | | |
| MFD 1310 (nm) | 8.16 | 7.43 | 7.82 | 7.71 | 8.07 | 8.00 | 7.75 | 7.93 | 7.81 |
| MFD 1550 (nm) | 9.54 | 8.85 | 9.14 | 8.99 | 9.54 | 9.33 | 8.91 | 9.24 | 9.25 |
| Expanded MFD | 9.22 | 8.90 | 8.93 | 8.83 | 9.39 | 9.09 | 8.65 | 9.01 | 9.15 |
| 1310 (microns) | | | | | | | | | |
| Expanded MFD | 11.37 | 11.34 | 11.1 | 10.8 | 11.65 | 11.21 | 10.48 | 11.12 | 11.55 |
| 1550 (microns) | | | | | | | | | |
| Pin Array | 1.97 | 0.01 | 1.34 | 0.02 | 2.15 | 1.05 | 0.01 | 0.02 | 1.39 |
| 1310 (dB) | | | | | | | | | |
| Pin Array | 5.11 | 3.33 | 4.42 | 1.92 | 5.51 | 3.80 | 0.49 | 3.01 | 4.44 |
| 1360 (dB) | | | | | | | | | |
| Pin Array | 43.98 | 42.04 | 44.81 | 26.84 | 47.15 | 37.61 | 15.38 | 32.93 | 44.36 |
| 1550 (dB) | | | | | | | | | |
| LP11 cutoff | 1130 | 1071 | 1047 | 1062 | 1079 | 1096 | 1120 | 1141 | 1152 |
| (nm) | | | | | | | | | |
| LP02 cutoff | 1332 | 1331 | 1196 | 1159 | 1210 | 1248 | 1207 | 1368 | 1397 |
| (nm) | | | | | | | | | |
| FOTP-170 | 1182 | 1181 | 1046 | 1009 | 1060 | 1098 | 1057 | 1218 | 1247 |
| Cable Cutoff | | | | | | | | | |

TABLE 5D

| Example | 43 | 44 | 45 | 46 | 47 | 48 | 49 | 50 | 51 |
|---|---|---|---|---|---|---|---|---|---|
| Dispersion 1260 | −8.86 | −8.12 | −7.39 | −7.78 | −6.06 | −6.18 | −6.36 | −6.45 | −6.43 |
| nm (ps/nm/km) | | | | | | | | | |
| Dispersion 1310 | −4.65 | −3.84 | −3.17 | −3.55 | −1.68 | −1.82 | −2.03 | −2.07 | −2.06 |
| nm (ps/nm/km) | | | | | | | | | |
| Dispersion 1330 | −3.12 | −2.28 | −1.64 | −2.02 | −0.08 | −0.23 | −0.45 | −0.47 | −0.47 |
| nm (ps/nm/km) | | | | | | | | | |
| Dispersion 1360 | −0.97 | −0.08 | 0.52 | 0.14 | 2.17 | 2.02 | 1.77 | 1.78 | 1.77 |
| nm (ps/nm/km) | | | | | | | | | |
| Dispersion 1550 | 9.62 | 11.05 | 11.22 | 10.77 | 13.47 | 13.31 | 12.91 | 13.01 | 12.95 |
| nm (ps/nm/km) | | | | | | | | | |
| Slope 1310 nm | 0.078 | 0.080 | 0.079 | 0.079 | 0.082 | 0.082 | 0.081 | 0.082 | 0.082 |
| (ps/nm²/km) | | | | | | | | | |
| Slope 1360 nm | 0.069 | 0.071 | 0.069 | 0.069 | 0.072 | 0.072 | 0.071 | 0.072 | 0.072 |
| (ps/nm²/km) | | | | | | | | | |
| Slope 1550 nm | 0.046 | 0.050 | 0.047 | 0.046 | 0.050 | 0.050 | 0.049 | 0.049 | 0.049 |
| (ps/nm²/km) | | | | | | | | | |
| Zero Dispersion | 1374 | 1361 | 1353 | 1358 | 1330 | 1332 | 1335 | 1335 | 1335 |
| (nm) | | | | | | | | | |
| MFD 1310 (nm) | 7.69 | 8.11 | 7.95 | 8.04 | 8.46 | 8.34 | 8.32 | 7.90 | 8.08 |
| MFD 1550 (nm) | 9.08 | 9.57 | 9.32 | 9.47 | 9.81 | 9.67 | 9.67 | 9.11 | 9.35 |
| Expanded MFD | 8.95 | 9.34 | 9.16 | 9.25 | 9.36 | 9.29 | 9.32 | 8.83 | 9.03 |
| 1310 (microns) | | | | | | | | | |
| Expanded MFD | 11.17 | 11.51 | 11.32 | 11.51 | 11.34 | 11.26 | 11.34 | 10.62 | 9.03 |
| 1550 (microns) | | | | | | | | | |
| Pin Array | 0.02 | 2.06 | 1.20 | 2.24 | 2.04 | 1.12 | 1.78 | 0.01 | 0.01 |
| 1310 (dB) | | | | | | | | | |
| Pin Array | 3.00 | 5.32 | 4.05 | 5.68 | 4.98 | 3.61 | 4.65 | 0.99 | 2.01 |
| 1360 (dB) | | | | | | | | | |
| Pin Array | 35.40 | 45.45 | 39.84 | 49.28 | 39.54 | 32.34 | 39.19 | 17.69 | 23.91 |
| 1550 (dB) | | | | | | | | | |
| LP11 cutoff | 1107 | 1087 | 1085 | 1155 | 1158 | 1149 | 1140 | 1143 | 1172 |
| (nm) | | | | | | | | | |
| LP02 cutoff | 1367 | 1253 | 1295 | 1418 | 1350 | 1295 | 1341 | 1364 | 1401 |
| (nm) | | | | | | | | | |
| FOTP-170 | 1217 | 1103 | 1145 | 1258 | 1200 | 1145 | 1191 | 1214 | 1251 |
| Cable Cutoff | | | | | | | | | |

It will be apparent to those skilled in the art that various modifications and variations can be made to the embodiments described herein without departing from the spirit and scope of the claimed subject matter. Thus it is intended that the specification cover the modifications and variations of the various embodiments described herein provided such modification and variations come within the scope of the appended claims and their equivalents.

What is claimed is:

1. An optical fiber, comprising:
a central core region having an outer radius r₁ of 3 μm to 7 μm, and a maximum refractive index Δ₁ of 0.25% to 0.5% and an alpha (a) profile of 1 to 20; and
a cladding region comprising (i) a first inner cladding region surrounding the central core, having a refractive index Δ₂ of −0.25% to 0.05% and a radius r₂ of 6 μm to 15 μm, (ii) a second inner cladding region, surrounding the first inner cladding region, having a refractive index Δ₃ of −0.1% to 0.2% and a radius r₃ of 7 μm to 15 μm, and (iii) an outer cladding region, surrounding the second inner cladding region, having a refractive index Δ₄ between −0.05% to 0.1%;
wherein the optical fiber exhibits a cable cutoff of less than 1260 nm, a mode field diameter at 1310 nm of greater than 8.2 microns and a chromatic dispersion slope at 1310 nm of less than or equal to 0.083 ps/nm²/km.

2. The optical fiber of claim 1, wherein the outer radius r₁ of the central core is 3.5 μm to 5.5 μm.

3. The optical fiber of claim 1, wherein the maximum refractive index Δ₁ of the central core is 0.3% to 0.45%.

4. The optical fiber of claim 1, wherein the refractive index Δ₂ of the first inner cladding region is 0 to −0.2%.

5. The optical fiber of claim 1, wherein the outer radius r₂ of the first inner cladding region is 6 μm to 12 μm.

6. The optical fiber of claim 1, wherein the refractive index Δ₃ of the second inner cladding region is 0.05% to 0.15%.

7. The optical fiber of claim 1, wherein the optical fiber exhibits a zero-dispersion wavelength λ₀ of less than 1400 nm.

8. The optical fiber of claim 1, wherein the optical fiber exhibits a zero-dispersion wavelength λ₀ of 1300 nm to 1324 nm.

9. The optical fiber of claim 1, wherein the optical fiber exhibits an attenuation at 1310 nm and 1383 nm of less than 0.33 dB/km.

10. The optical fiber of claim 1, wherein the optical fiber exhibits a mode field diameter greater than 8.5 microns at 1310 nm.

11. The optical fiber of claim 1, wherein the optical fiber exhibits a chromatic dispersion slope at 1310 nm of less than or equal to 0.07 ps/nm²/km.

12. The optical fiber of claim 1, wherein the optical fiber exhibits a chromatic dispersion at 1310 nm of greater than −7 ps/nm/km.

13. The optical fiber of claim 1, wherein the optical fiber exhibits a chromatic dispersion at 1380 nm of less than 5 ps/nm/km.

14. The optical fiber of claim 1, wherein the optical fiber exhibits a chromatic dispersion at 1260 nm of greater than −10 ps/nm/km.

15. The optical fiber of claim 1, wherein the optical fiber exhibits a bend loss of less than 0.00001 dB/turn when would upon a 60 mm radius mandrel.

16. An optical fiber, comprising:
a central core region having an outer radius r₁ of 3 μm to 5.5 μm, and a maximum refractive index Δ₁ of 0.25% to 0.5% and an alpha (α) profile of 1 to 20; and
a cladding region comprising (i) a first inner cladding region surrounding the central core, having a refractive index Δ₂ of −0.25% to 0.05% and a radius r₂ of 6 μm to 12 μm, (ii) a second inner cladding region, surrounding the first inner cladding region, having a refractive index Δ₃ of 0.02% to 0.2% and a radius r₃ of 7 μm to 15 μm, and (iii) an outer cladding region, surrounding the second inner cladding region, having a refractive index Δ₄ between −0.05% to 0.1%;
wherein the optical fiber exhibits a cable cutoff of less than 1260 nm, mode field diameter at 1310 nm of greater than 8.2 microns, a zero dispersion wavelength between 1300 nm and 1324 nm and a chromatic dispersion slope at 1310 nm of less than or equal to 0.083 ps/nm²/km.

17. The optical fiber of claim 16, wherein the optical fiber exhibits a mode field diameter at 1310 nm of greater than 8.6 microns.

18. An optical fiber, comprising:
a central core region having an outer radius r₁ of 3 μm to 5.5 μm, and a maximum refractive index Δ₁ of 0.25% to 0.5% and an alpha (α) profile of 1 to 20; and
a cladding region comprising (i) a first inner cladding region surrounding the central core, having a refractive index Δ₂ of −0.25% to 0.05% and a radius r₂ of 6 μm to 12 μm, (ii) a second inner cladding region, surrounding the first inner cladding region, having a refractive index Δ₃ of 0.02% to 0.2% and a radius r₃ of 7 μm to 15 μm, and (iii) an outer cladding region, surrounding the second inner cladding region, having a refractive index Δ₄ between −0.05% to 0.1%;
wherein the optical fiber exhibits a cable cutoff of less than 1260 nm, a mode field diameter at 1310 nm of greater than 8.2 microns, a zero dispersion wavelength of less than 1400 nm and a chromatic dispersion slope at 1310 nm of less than or equal to 0.075 ps/nm²/km.

19. The optical fiber of claim 18, wherein the optical fiber exhibits a zero dispersion wavelength of less than 1390 nm.

20. The optical fiber of claim 18, wherein the optical fiber exhibits a dispersion slope of less than 0.07 ps/nm2/km at 1310 nm.
